(19) United States
(12) Patent Application Publication
(10) Pub. No.: US 2012/0133107 A1
(43) Pub. Date: May 31, 2012

(54) BICYCLE SEAT POST

(75) Inventor: Douglas CHIANG, TAICHUNG CITY (TW)

(73) Assignee: TIEN HSIN INDUSTRIES CO., LTD., Wufeng Dist. (TW)

(21) Appl. No.: 13/010,090

(22) Filed: Jan. 20, 2011

(30) Foreign Application Priority Data
Nov. 25, 2010 (TW) 99140841

(51) Int. Cl. B62K 19/36; B62K 19/02

(52) U.S. Cl. 280/281.1

(57) ABSTRACT

A bicycle seat post includes a head for mounting with a seat, and a tubular body extending downwards from the head and having a hollow portion at a periphery thereof for insertion of a seat tube. Thus, the bicycle scat post can offer a flexible structure to increase the effective contact area between the tubular body and the seat tube, such that the bicycle seat post can be thinly fixed to the seat tube for enhancing the structural stabilization.

### BACKGROUND OF THE INVENTION

1. Field of the Invention

The present invention relates generally to a bicycle seat post, and more specifically to a bicycle seat post having a flexible tubular body for firmly fixing on a seat tube.

2. Description of the Related Art

A conventional bicycle seat post is set between a seat and a seat tube for supporting the total weight from the seat. During the assembly of the conventional bicycle seat post, it is inserted into the seat tube and fixed by a clamping device, such as a quick release, installed on the top end of the seat tube. However, the seat post and the seat tube may be deformed during the manufacturing process so as to generate a gap therebetween when the seat post is inserted into the seat tube, and therefore vibration and noise will occur due to the existence of the gap even though the clamping device is locked, resulting in that the seat post has to be made with great precision for eliminating the gap. Further, the seat post and the seat tube may be interfered with each other because of their deformation, such that the seat post may easily get damage when it is rotated relative to the seat tube for adjusting the angle of the seat or detached from the seat tube, reducing the durability of the seat post.

Besides, the scat post may has a hole at the bottom end thereof to permit insertion of the top end of the seat tube such that the top end of the seat tube can be abutted against an end wall of the hole of the seat post for enhancing structural stabilization of the seat post. By this way, the effective contact area between the seat post and the seat tube is too limited, and the interference still exists between the seat post and the seat tube. Thus, it is desirable to provide an improved seat post that can eliminate the aforesaid drawbacks.

### SUMMARY OF THE INVENTION

It is one objective of the present invention to provide a bicycle seat post, which has a flexible tubular body to increase the contact area and reduce the interference between the tubular body and a seat tube for firmly securing on the seat tube.

To achieve this objective of the present invention, the bicycle seat post provided by the present invention comprises a head for mounting with a seat, and a tubular body for mounting with a seat tube. The tubular body is connected with the head and extends downwards from the head and has a hollow portion at a periphery thereof. When the bicycle seat post of the present invention is configured to the seat tube through the tubular body, the tubular body can be deformed to be matched with the cross-sectional shape of the seat tube through its hollow portion, such that the effective contact area between the tubular body and the seat tube can be enhanced, and the interference between the tubular body and the seat tube can be reduced.

Preferably, the tubular body has a first lateral side and a second lateral side opposite to the first lateral side, and the hollow portion can be located at the first lateral side of the tubular body, or extend from the second lateral side to the first lateral side of the tubular body.

Preferably, the hollow portion of the tubular body extends to a bottom end of the tubular body, and two clamping portions are provided at the bottom end of the tubular body and spaced by the hollow portion for installation of a clamping device.

Preferably, the tubular body has a water-drop cross section to enhance its flexibility.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a bicycle seat post according to a preferred embodiment of the prevent invention;

FIG. 2 is another perspective view of the bicycle seat post according to the preferred embodiment of the prevent invention;

FIG. 3 is a front view of the bicycle seat post according to the preferred embodiment of the prevent invention;

FIG. 4 is a rear view of the bicycle seat post according to the preferred embodiment of the prevent invention;

FIG. 5 is a right side view of the bicycle seat post according to the preferred embodiment of the prevent invention;

FIG. 6 is a left side view of the bicycle seat post according to the preferred embodiment of the prevent invention; and

FIG. 7 is a sectional view taken along line 7-7 of FIG. 5.

### DETAILED DESCRIPTION OF THE INVENTION

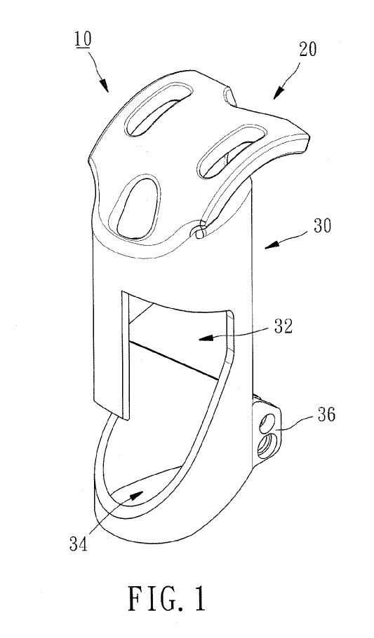

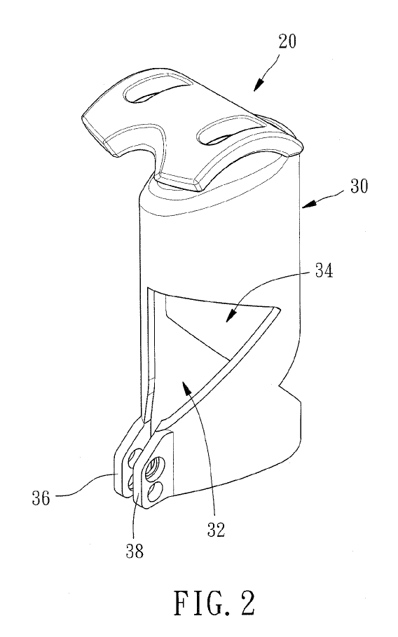

As shown in FIGS. 1-2, a bicycle seat post 10 in accordance with a preferred embodiment of the present invention comprises a head 20 and a tubular body 30.

The head 20 is made of carbon fiber for mounting with a seat.

The tubular body 30 is made of aluminum, and connected with the head 20 and extends downwards from the head 20 for insertion of a seat tube. The tubular body 30 has a water-drop cross section, as shown in FIG. 7, a first hollow portion 32 at a periphery thereof, and a second hollow portion 34 at the periphery thereof.

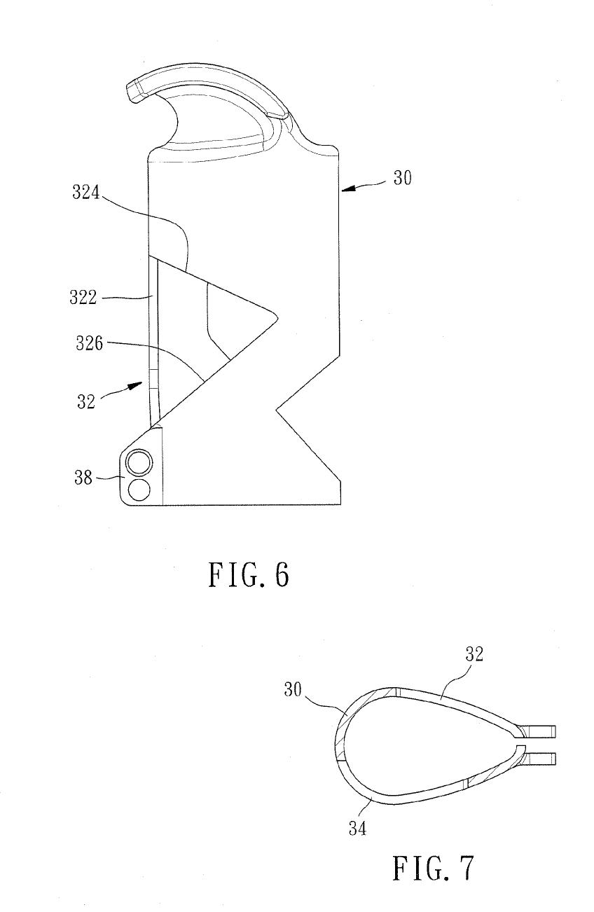

As shown in FIGS. 4 and 6, the first hollow portion 32 is located at a first lateral side 304 of the tubular body 30, having a first edge 322 extending downwards to a bottom end of the tubular body 30, an inclined second edge 324 extending downwards from a top end of the first edge 322 to a front side of the tubular body 30, and an inclined third edge 326 extending downwards from a front end of the second edge 324 to the bottom end of the tubular body 30. A first clamping portion 36 is provided at the bottom end of tubular body 30 and located near the first edge 322, and a second clamping portion 38 is provided at the bottom end of tubular body 30 and located near the third edge 326 so as to be spaced from the first clamping portion 36. By this way, a clamping device, such as a quick release or a nut and a bolt, can be attached to the first and second clamping portions 36 and 38 to tighten the first and second clamping portions 36 and 38 for securing the tubular body 30 to the seat tube.

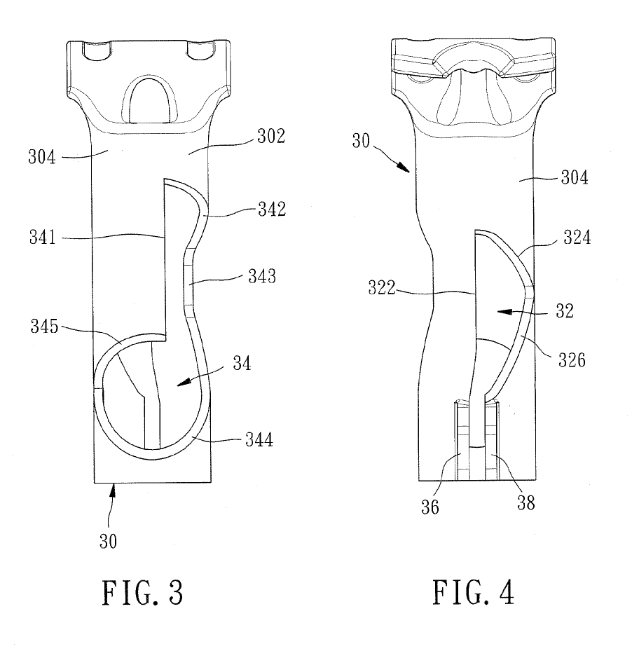

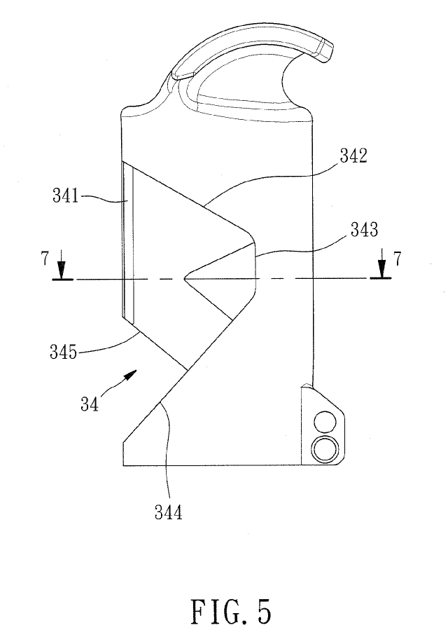

As shown in FIGS. 3 and 5, the second hollow portion 34 extends from a second lateral side 302 of the tubular body 30, which is opposite to the first lateral side 304, to the first lateral side 304 through the front side of the tubular body 30, having a straight first edge 341 extending downwards along an axial direction of the tubular body 30, an inclined second edge 342 extending downwards from a top end of the first edge 341 to the rear side of the tubular body 30, a straight third edge 343 extending downwards from a rear end of the second edge 342, a curved forth edge 344 extending inclinedly and downwards from a bottom end of the third edge 343 to the first lateral side 304 of the tubular body 30, and a curved fifth edge 345 extending upwards from a bottom end of the forth edge 344 to a bottom end of the first edge 341. To deserve to be mentioned, the number of the hollow portion is not limited to the above-mentioned embodiment, that is to say, the tubular body can be provided with one or more hollow portions; and further, the shape of the hollow portion can be varied in numerous ways to provide a dramatic visual effect in the appearance of the tubular body.

By means of the aforesaid design, since the tubular body 30 has the first and second hollow portions 32 and 34 and the water-drop cross section, the tubular body 30 can be designed to add its length and reduce its thickness, and furthermore it can be deformed when fixed to the seat tube by the clamping device. Therefore, even though the seat tube gets deformed during the manufacturing process, the bicycle seat post 10 of the present invention can be fitted to the seat tube through its flexibility so that the effective contact area between the tubular body 30 and the seat tube can be increased, and the interference between the tubular body 30 and the seat tube can be reduced, thereby attaining the purpose of enhancing the structural stabilization of the bicycle seat post 10 and preventing the bicycle seat post 10 from getting damage.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A bicycle seat post comprising:
a head; and
a tubular body connected with the head and extending downwards from the head and having a hollow portion at a periphery thereof.

2. The bicycle seat post as claimed in claim 1, wherein the periphery of the tubular body defines a first lateral side and a second lateral side opposite to the first lateral side; the hollow portion is located at the first lateral side.

3. The bicycle seat post as claimed in claim 2, wherein the hollow portion of the tubular body extends to a bottom end of the tubular body, and two clamping portions are provided at the bottom end of the tubular body and divided by the hollow portion.

4. The bicycle seat post as claimed in claim 3, wherein the hollow portion has a first edge extending downwards to the bottom end of the tubular body, an inclined second edge extending downwards from a top end of the first edge to a front side of the tubular body, and an inclined third edge extending downwards from a front end of the second edge to the bottom end of the tubular body; the clamping portions are respectively located near the first edge and the third edge.

5. The bicycle scat post as claimed in claim 1, wherein the periphery of the tubular body defines a first lateral side and a second lateral side opposite to the first lateral side; the hollow portion extends from the second lateral side to the first second side.

6. The bicycle seat post as claimed in claim 5, wherein the hollow portion a straight first edge extending downwards along an axial direction of the tubular body, an inclined second edge extending downwards from a top end of the first edge to a rear side of the tubular body, a straight third edge extending downwards from a rear end of the second edge, a curved forth edge extending inclinedly and downwards from a bottom end of the third edge to the first lateral side of the tubular body, and a curved fifth edge extending upwards from a bottom end of the forth edge to a bottom end of the first edge.

7. The bicycle seat post as claimed in claim 1, wherein the tubular body has a water-drop cross section.
